(19) United States
(12) Patent Application Publication
(10) Pub. No.: US 2024/0291929 A1
(43) Pub. Date: Aug. 29, 2024

(54) IMAGE READING DEVICE AND IMAGE READING METHOD

(71) Applicant: SEIKO EPSON CORPORATION, Tokyo (JP)

(72) Inventor: Hikari ISHIHARA, KITAKYUSHU-SHI (JP)

(21) Appl. No.: 18/586,840

(22) Filed: Feb. 26, 2024

(30) Foreign Application Priority Data
Feb. 27, 2023 (JP) 2023-028136

(51) Int. Cl. H04N 1/401; H04N 1/00

(52) U.S. Cl. CPC H04N 1/401; H04N 1/00045; H04N 1/00814

(57) ABSTRACT

The image reading device includes a light source configured to emit light, a reference portion for shading correction, a reading unit configured to read a document and output read data, and a control unit. One of first black reference data and first white reference data is data that is obtained by reading the reference portion by the reading unit with the light source turned on and that is potentially affected by dirt. The control unit sets a document region based on a first result obtained by executing shading correction based on a difference between the read data and the first black reference data and a difference between the first white reference data and the first black reference data.

The present application is based on, and claims priority from JP Application Serial Number 2023-028136, filed Feb. 27, 2023, the disclosure of which is hereby incorporated by reference herein in its entirety.

### BACKGROUND

### 1. Technical Field

The present disclosure relates to an image reading device and an image reading method.

### 2. Related Art

For example, as described in JP-A-2020-17856, there is an image reading device including a reading unit configured to read an image on a document. The image reading device is capable of adjusting the sensitivity of detection of dirt adhering to a reading surface. The image reading device displays a warning message when it detects the adhesion of dirt.

If the sensitivity of detection of dirt is increased, dirt can be easily detected, but erroneous detection and excessive detection increase the warning frequency, resulting in deterioration in sense of use. However, if the sensitivity is lowered in order to allow a certain degree of contamination, there is a possibility that the accuracy of cutting out a document may be lowered due to dirt that cannot be detected.

### SUMMARY

An image reading device that solves the above problem includes a light source configured to emit light, a reference portion for shading correction, a reading unit configured to read a document and output read data, and a control unit, in which one of first black reference data and first white reference data is data that is obtained by reading the reference portion by the reading unit with the light source turned on and that is potentially affected by dirt, and the control unit sets a document region based on a first result obtained by executing shading correction based on a difference between the read data and the first black reference data and a difference between the first white reference data and the first black reference data.

An image reading method that solves the above problem is an image reading method for an image reading device including a light source that emits light, a reference portion for shading correction, and a reading unit that reads a document and outputs read data, in which one of first black reference data and first white reference data is data that is obtained by reading the reference portion by the reading unit with the light source turned on and that is potentially affected by dirt, and a document region is set based on a first result obtained by executing shading correction based on a difference between the read data and the first black reference data and a difference between the first white reference data and the first black reference data.

### BRIEF DESCRIPTION OF THE DRAWINGS

FIG. 1 is a side view illustrating an image reading device according to a first embodiment.

FIG. 2 is a schematic diagram of a second reading unit.

FIG. 3 is a schematic diagram of a read image.

FIG. 4 is a schematic diagram of a setting image.

### DESCRIPTION OF EMBODIMENTS

Hereinafter, an image reading device and an image reading method will be described with reference to the accompanying drawings. The image reading device is, for example, a sheet feed scanner in which a fixed reading unit reads a conveyed document of such as paper, film, and the like.

### First Embodiment

### Configuration of Image Reading Device

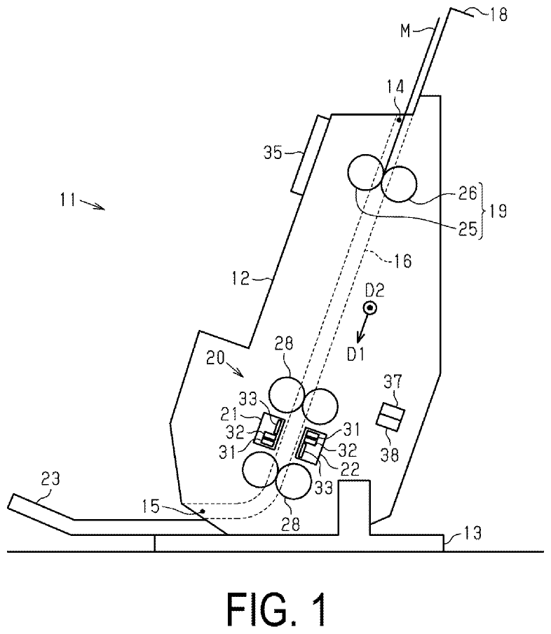

As illustrated in FIG. 1, an image reading device 11 may include a housing 12 and a support portion 13. The support portion 13 supports the housing 12. The support portion 13 is attached to the housing 12. The support portion 13 is installed, for example, on a horizontal plane.

A supply port 14 and an ejection port 15 are formed in the housing 12. The supply port 14 is an opening through which a document M is supplied. The document M is supplied into the housing 12 through the supply port 14. The ejection port 15 is an opening through which the document M is ejected. The document M is ejected from the housing 12 through the ejection port 15.

The image reading device 11 may include a conveyance path 16. The conveyance path 16 is a path through which the document M is conveyed. The conveyance path 16 extends in the housing 12. The conveyance path 16 extends from the supply port 14 toward the ejection port 15.

The image reading device 11 may include a supply tray 18, a feeding unit 19, a conveying unit 20, a first reading unit 21, a second reading unit 22, and an ejection tray 23.

The supply tray 18 is attached to the housing 12. The document M before reading is set on the supply tray 18. One or more documents M are stacked on the supply tray 18. The document M is set on the supply tray 18 in a state in which the leading end of the document M enters the supply port 14. When the document M is set on the supply tray 18, the leading end of the document M abuts against the feeding unit 19.

The feeding unit 19 includes a feeding roller 25 and a separation unit 26. The feeding unit 19 sequentially feeds a plurality of documents M placed at the supply tray 18 one by one to the conveyance path 16.

The feeding roller 25 feeds the document M from the supply tray 18. The feeding roller 25 is driven to rotate. The feeding roller 25 may come into contact with the surface of the document M.

The separation unit 26 separates the document M fed by the feeding roller 25. The separation unit 26 according to the present embodiment is a roller for separating the documents M one by one. The separation unit 26 may come into contact with the reverse surface of the document M.

The separation unit 26 includes, for example, a roller having a higher friction coefficient with respect to the documents M than the friction coefficient between the documents M. For example, a torque limiter applies a rotational load to the separation unit 26. Therefore, when the feeding roller 25 and the separation unit 26 sandwich the plurality of documents M, the separation unit 26 is less likely to rotate following the driving rotation of the feeding roller 25. That is, the documents M are separated one by one by the feeding roller 25 and the separation unit 26. This reduces the possibility that the two documents M are conveyed in an overlapping state.

The conveying unit 20 is configured to convey the document M. The conveying unit 20 conveys the document M along the conveyance path 16. The conveying unit 20 includes, for example, one or more roller pairs 28.

The roller pair 28 is provided downstream of the feeding unit 19 in a conveying direction D1. The plurality of roller pairs 28 are arranged along the conveyance path 16. The roller pair 28 conveys the document M by rotating while sandwiching the document M.

The ejection tray 23 is attached to the housing 12. The ejection tray 23 is rotatable with respect to, for example, the housing 12. The ejection tray 23 can receive the document M by opening to the housing 12. The ejection tray 23 receives the document M after reading. The ejection tray 23 receives the document M ejected from the ejection port 15.

The first reading unit 21 and the second reading unit 22 are configured to read the document M. The first reading unit 21 and the second reading unit 22 read the document M conveyed in the conveying direction D1. The first reading unit 21 and the second reading unit 22 face each other through the conveyance path 16. The first reading unit 21 and the second reading unit 22 are long in a scanning direction D2. When the scanning direction D2 is referred to as a main scanning direction, it can be said that the conveying direction D1 is a sub-scanning direction.

The first reading unit 21 and the second reading unit 22 have the same configuration. Each of the first reading unit 21 and the second reading unit 22 includes a light source 31, a reading unit 32, and a reference portion 33.

The light source 31 is, for example, an LED, a fluorescent lamp, or the like. The light source 31 emits light. Specifically, the light source 31 irradiates the facing reading unit with light. The light source 31 is, for example, long in the scanning direction D2.

The reading unit 32 reads the document M and outputs the read data. The reading unit 32 may read an image of one line in the scanning direction D2. The reading unit 32 may output the read data including a plurality of pixels arranged in the scanning direction D2. The reading unit 32 may include a plurality of image sensors arranged in the scanning direction D2. The plurality of image sensors may be modularized. The reading unit 32 is, for example, a contact type image sensor. Specifically, the reading unit 32 is a CMOS image sensor. the reading unit 32 photoelectrically converts received light. The reading unit 32 outputs an output value corresponding to the amount of received light. The output value obtained when the reading unit 32 reads the white document M is larger than the output value obtained when the black reference portion 33 is read. The output value is converted into a luminance value by A/D conversion.

The reading unit 32 may be a monochrome sensor or a color sensor. The reading unit 32 may be configured to read the document M in full color. For example, the reading unit 32 may be configured to read the document M in three colors of RGB. The reading unit 32 may be configured to read the document M in grayscale.

The reference portion 33 is for shading correction. The reference portion 33 is used for shading correction. The reference portion 33 faces, for example, the light source 31 and the reading unit 32 included in another reading unit. The reference portion 33 is irradiated with light from the facing light source 31. The reference portion 33 reflects the emitted light. The light reflected by the reference portion 33 is incident on the reading unit 32 facing the reference portion 33.

The reference portion 33 is read as a background together with the document M by the reading unit 32. The reference portion 33 may have a color that can distinguish between the document M and the reference portion 33 when the reading unit 32 reads the document M and the reference portion 33. The reference portion 33 according to the present embodiment is black.

The image reading device 11 reads the surface of the document M by the light source 31 and the reading unit 32 included in the first reading unit 21 and the reference portion 33 included in the second reading unit 22. The image reading device 11 reads the reverse surface of the document M using the light source 31 and the reading unit 32 included in the second reading unit 22 and the reference portion 33 included in the first reading unit 21.

The image reading device 11 may include an operation unit 35. The operation unit 35 is attached to, for example, the housing 12. The operation unit 35 is, for example, a touch panel. The operation unit 35 receives an operation from a user. The operation unit 35 is not limited to the touch panel and may be, for example, a button, a switch, or the like.

For example, the image reading device 11 may be configured to receive an operation from a terminal communicably connected to the image reading device 11. The terminal is, for example, a personal computer or a smartphone owned by the user.

The image reading device 11 includes a control unit 37. The control unit 37 comprehensively controls driving of each mechanism in the image reading device 11 and controls various operations executed in the image reading device 11.

The control unit 37 can be configured as a circuit including α: one or more processors that execute various processing according to a computer program, β: one or more dedicated hardware circuits that execute at least part of the various processing, and γ: a combination thereof. The hardware circuit is, for example, an application-specific integrated circuit. The processor includes a CPU and a memory such as a RAM and ROM, and the memory stores program codes or instructions configured to cause the CPU to execute processing. The memory or a computer-readable medium includes any readable medium that can be accessed by a general purpose or special purpose computer.

The image reading device 11 may include a storage unit 38. The storage unit 38 may be included in the control unit 37. The storage unit 38 may be, for example, a memory such as the RAM and the ROM described above.

### Dirt

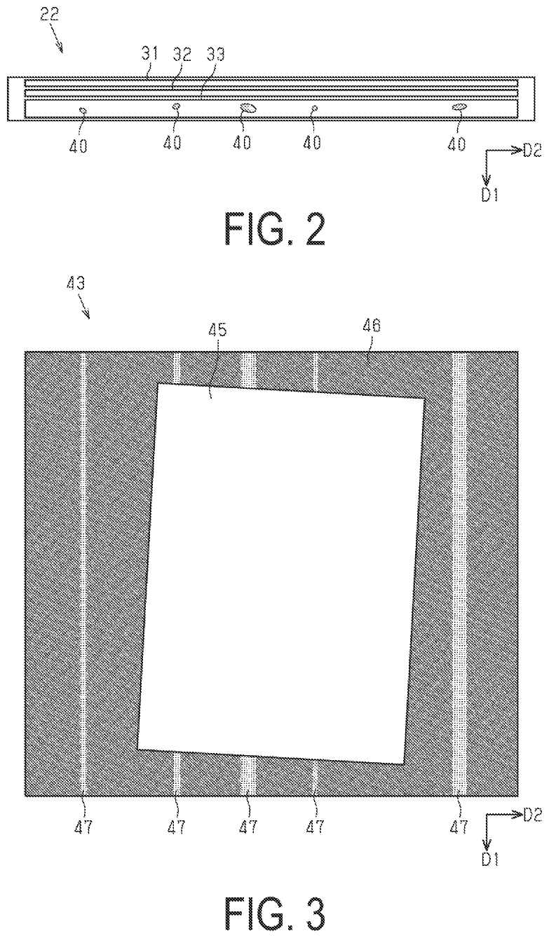

As illustrated in FIG. 2, for example, a foreign matter 40 such as paper dust or dust may adhere to first reading unit 21 and second reading unit 22. In the present embodiment, the attached foreign matter 40 is also referred to as dirt. In the present embodiment, the state in which the foreign matter 40 adheres is also referred to as a contaminated state. The foreign matter 40 also affects a reading operation when attached to the light source 31 and the reading unit 32. Referring to FIG. 2, in addition to the dirt on the reference portion 33 of the second reading unit 22, dirt on the light source 31 and the reading unit 32 of the first reading unit 21 is also projected and illustrated. Hereinafter, dirt on the light source 31 and the reading unit 32 will also be described as dirt on the reference portion 33.

### Image Reading Method

The image reading device 11 reads one side of the conveyed document M or both sides of the document M. The obverse surface and the reverse surface of the document M are read by the same method. Therefore, reading on one side will be described below.

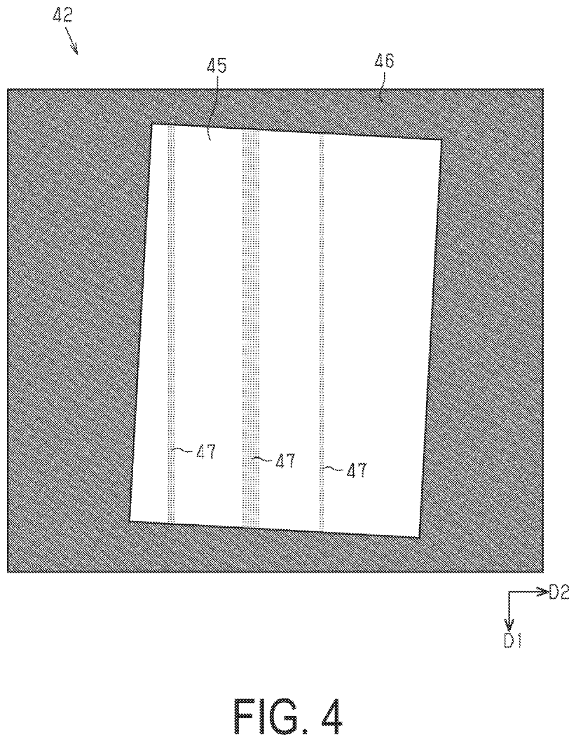

As illustrated in FIGS. 3 and 4, the control unit 37 may generate a setting image 42 and a read image 43 based on the read data read by the reading unit 32. FIGS. 3 and 4 illustrate the setting image 42 and the read image 43 when reading is performed with the reference portion 33 contaminated as illustrated in FIG. 2.

As illustrated in FIG. 3, the read image 43 includes a document region 45, a background region 46, and a dirt region 47. The document region 45 is a region where the document M is read. Background region 46 is a region obtained by reading the reference portion 33. The background region 46 according to the present embodiment is black. The dirt region 47 is a region where the foreign matter 40 is read. The dirt region 47 appears in a streak pattern extending in the conveying direction D1 at the position of the dirt in the scanning direction D2.

The control unit 37 generates the setting image 42 illustrated in FIG. 4 based on Equation 1 given below. The control unit 37 generates the read image 43 illustrated in FIG. 3 based on Equation 2 given below. Equations 1 and 2 are shading correction equations.

$$[ Math 1 ]$$

$$\frac{Read data - First black reference data}{\begin{matrix}First white reference data - \\ First black reference data\end{matrix}} \times Coefficient = First result \qquad ( 1 )$$

$$\frac{Read data - Second black reference data}{\begin{matrix}First white reference data - \\ Second black reference data\end{matrix}} \times Coefficient = Second result \qquad ( 2 )$$

The control unit 37 executes two patterns of shading correction for each pixel included in the read data. The control unit 37 may execute the shading correction according to Equation 2 after executing the shading correction according to Equation 1 or may execute the shading correction according to Equation 2 first.

The read data in Equations 1 and 2 is data obtained by the reading unit 32 that has read the document M.

The first black reference data is data obtained by reading the reference portion 33 by the reading unit 32 with the light source 31 turned on. The first black reference data may be affected by dirt.

The second black reference data is data not affected by dirt. The control unit 37 may generate the second black reference data by turning off the light source 31 and causing the reading unit 32 to read the reference portion 33.

Upon receiving an instruction to read the document M, the control unit 37 may generate the first black reference data and the second black reference data. The control unit 37 may generate the first black reference data and the second black reference data immediately before the document M is read. The first black reference data and the second black reference data may change depending on an environment such as temperature, a temporal change in the reading unit 32, and the like. Therefore, by generating the first black reference data and the second black reference data and reading the document M in the same environment, the influence of the environment can be reduced.

The first white reference data is data not affected by dirt. The first white reference data is, for example, data generated during manufacturing of the image reading device 11 and may be stored in the storage unit 38. The first white reference data is, for example, data obtained when the light source 31 is turned on and the reading unit 32 reads a white reference member before the light source 31, the reading unit 32, and the like are contaminated. The white reference member may be provided in the image reading device 11 or may be prepared separately from the image reading device 11.

As indicated by Equation 1, the control unit 37 sets the document region 45 based on the first result obtained by executing shading correction based on the difference between the read data and the first black reference data and the difference between the first white reference data and the first black reference data. Specifically, the control unit 37 divides the value obtained by subtracting the first black reference data from the read data by the value obtained by subtracting the first black reference data from the first white reference data. The control unit 37 calculates the first result by multiplying the calculated quotient by a coefficient corresponding to the number of color gradations. For example, in the case of 8 bits and 256 gradations, the control unit 37 multiplies 255 as a coefficient.

As illustrated in FIG. 4, in the setting image 42 generated based on Equation 1, the dirt region 47 in the portion overlapping the document region 45 is easily noticeable, whereas the dirt region 47 in the portion overlapping the background region 46 is not easily noticeable. Therefore, the control unit 37 hardly erroneously recognizes the dirt region 47 as an end of the document region 45. The control unit 37 sets the document region 45 based on the first result obtained by executing shading correction based on Equation 1. The control unit 37 may determine that a pixel is in the document region 45 if the first result is equal to or greater than a threshold value and may determine that a pixel is in the background region 46 if the first result is less than the threshold value.

As indicated by Equation 2, the control unit 37 cuts out the document region 45 from the second result obtained by executing shading correction based on the difference between the read data and the second black reference data and the difference between the first white reference data and the second black reference data. Specifically, the control unit 37 divides the value obtained by subtracting the second black reference data from the read data by the value obtained by subtracting the second black reference data from the first white reference data. The control unit 37 calculates the second result by multiplying the calculated quotient by a coefficient corresponding to the number of color gradations. The coefficients in Equation 2 are the same as the coefficients in Equation 1. The control unit 37 may generate the read image 43 from the second result according to Equation 2.

As illustrated in FIG. 3, in the read image 43 generated based on Equation 2, the dirt region 47 in the portion overlapping the document region 45 is not easily noticeable, whereas the dirt region 47 in the portion overlapping the background region 46 is easily noticeable. That is, the background region 46 and the dirt region 47 have a large luminance difference. Therefore, when the document region 45 is cut out based on the luminance difference, the control unit 37 may erroneously recognize the dirt region 47 as an end of the document region 45 and cut out a region different from the document region 45. In this regard, the control unit 37 acquires an image on the document M by cutting out the range of the document region 45 set based on the first result from the read image 43 that is the second result.

### Actions of First Embodiment

Actions of the present embodiment will be described.

The storage unit 38 may store the first white reference data for the obverse surface of the document M and the first white reference data for the reverse surface of the document M.

Upon receiving an instruction to read the document M, the control unit 37 generates the first black reference data and the second black reference data before the leading end of the document M reaches the first reading unit 21 and the second reading unit 22. When reading both sides of the document M, the control unit 37 may generate the first black reference data and the second black reference data for the obverse surface of the document M and the first black reference data and the second black reference data for the reverse surface of the document M.

For example, every time the reading unit 32 reads one line of the document M, the control unit 37 may perform shading correction according to Equations 1 and 2 with respect to the read data. In the case of reading both sides, the control unit 37 may perform shading correction according to Equations 1 and 2 with respect to the read data of the obverse and reverse surfaces. The control unit 37 may output the image on the document region 45 cut out from the read image 43 after correcting the inclination.

### Effects of First Embodiment

Effects of the present embodiment will be described.

(1-1) The first black reference data is data that may be affected by dirt. By executing shading correction using the first white reference data and the first black reference data, it is possible to reduce the influence of dirt on the background region 46 different from the document region 45. Therefore, by setting the document region 45 based on the first result, the accuracy of cutting out the document M can be improved.

(1-2) The first white reference data and the second black reference data are data that are not affected by dirt. By performing shading correction using the second black reference data and the first white reference data, it is possible to reduce the influence of dirt on the document region 45. Therefore, by cutting out the document region 45 set based on the first result from the second result, it is possible to cut out an image on which the influence of dirt is reduced.

(1-3) Upon receiving an instruction to read the document M, the control unit 37 may generate the first black reference data and the second black reference data. That is, since the control unit 37 uses data immediately before reading the document M, it is possible to execute highly accurate shading correction.

(1-4) The control unit 37 generates the second black reference data by causing the reference portion 33 to be read with the light source 31 turned off. Therefore, it is possible to easily generate the second black reference data not affected by dirt.

### Second Embodiment

Next, the second embodiment of an image reading device will be described. In the second embodiment, the color of a reference portion is different from that of the first embodiment. Further, since other points are substantially the same as those of the first embodiment, duplicate descriptions of the same configuration will be omitted while assigning the same reference signs to the same components. The reference portion 33 according to the present embodiment is white. A background region 46 according to the present embodiment is white.

### Image Reading Method

A control unit 37 generates a setting image 42 based on Equation 3 given below and generates a read image 43 based on Equation 4. Equations 3 and 4 are equations for shading correction. The control unit 37 executes two patterns of shading correction for each pixel. The control unit 37 may execute shading correction according to Equation 3 and then execute shading correction according to Equation 4 or may execute shading correction according to Equation 4 first.

$$[ Math 2 ]$$

$$\frac{Read data - First black reference data}{\begin{matrix}First white reference data - \\ First black reference data\end{matrix}} \times Coefficient = First result \qquad ( 3 )$$

$$\frac{Read data - First black reference data}{\begin{matrix}Second white reference data - \\ First black reference data\end{matrix}} \times Coefficient = Second result \qquad ( 4 )$$

The read data in Equations 3 and 4 is data obtained by a reading unit 32 that has read the document M.

The first white reference data is data obtained by reading the reference portion 33 by the reading unit 32 with the light source 31 turned on. The first white reference data may be affected by dirt.

The first black reference data is data not affected by dirt. The control unit 37 may generate the first black reference data by turning off the light source 31 and causing the reading unit 32 to read the reference portion 33.

Upon receiving an instruction to read the document M, the control unit 37 may generate the first white reference data and the first black reference data. The control unit 37 may generate the first white reference data and the first black reference data immediately before the document M is read. The first white reference data and the first black reference data may change depending on an environment such as temperature, a temporal change in the reading unit 32, and the like. Therefore, by generating the first white reference data and the first black reference data and reading the document M in the same environment, the influence of the environment can be reduced.

The second white reference data is data not affected by dirt. The second white reference data is, for example, data generated during manufacturing of an image reading device 11 and may be stored in a storage unit 38. The second white reference data is, for example, data obtained when the light source 31 is turned on and the reading unit 32 reads the reference portion 33 before the light source 31, the reading unit 32, and the reference portion 33 are contaminated.

The control unit 37 may correct the second white reference data stored in the storage unit 38 before executing shading correction. For example, the control unit 37 obtains the difference between the moving average of the first white reference data generated before reading the document M and the moving average of the second white reference data stored in the storage unit 38. Based on the calculated difference, the control unit 37 may correct the overall height of the second white reference data to match the first white reference data.

As indicated by Equation 3, the control unit 37 sets a document region 45 based on the first result obtained by executing shading correction based on the difference between the read data and the first black reference data and the difference between the first white reference data and the first black reference data. Specifically, the control unit 37 divides the value obtained by subtracting the first black reference data from the read data by the value obtained by subtracting the first black reference data from the first white reference data. The control unit 37 calculates the first result by multiplying the calculated quotient by a coefficient corresponding to the number of color gradations.

The control unit 37 sets the document region 45 based on the first result obtained by executing shading correction based on Equation 3. The control unit 37 may determine that a pixel is in the document region 45 if the first result is equal to or less than a threshold value and may determine that a pixel is in the background region 46 if the first result is larger than the threshold value.

As indicated by Equation 4, the control unit 37 cuts out the document region 45 from the second result obtained by executing shading correction based on the difference between the read data and the first black reference data and the difference between the second white reference data and the first black reference data. Specifically, the control unit 37 divides the value obtained by subtracting the first black reference data from the read data by the value obtained by subtracting the first black reference data from the second white reference data. The control unit 37 calculates the second result by multiplying the calculated quotient by a coefficient corresponding to the number of color gradations. The coefficients in Equation 4 are the same as the coefficients in Equation 3. The control unit 37 may generate the read image 43 from the second result according to Equation 4. The control unit 37 acquires an image on the document M by cutting out the range of the document region 45 set based on the first result from the read image 43 that is the second result.

### Actions of Second Embodiment

Actions of the present embodiment will be described.

The storage unit 38 may store the second white reference data for the obverse surface of the document M and the second white reference data for the reverse surface of the document M.

Upon receiving an instruction to read the document M, the control unit 37 generates the first white reference data and the first black reference data before the leading edge of the document M reaches a first reading unit 21 and a second reading unit 22. When reading both sides of the document M, the control unit 37 may generate the first white reference data and the first black reference data for the obverse surface of the document M and the first white reference data and the first black reference data for the reverse surface of the document M.

For example, every time the reading unit 32 reads one line of the document M, the control unit 37 may perform shading correction according to Equations 3 and 4 with respect to the read data. In the case of reading both sides, the control unit 37 may perform shading correction according to Equations 3 and 4 with respect to the read data of the obverse and reverse surfaces. The control unit 37 may output the image on the document region 45 cut out from the read image 43 after correcting the inclination.

### Effects of Second Embodiment

Effects of the present embodiment will be described.

(2-1) The first white reference data is data that is potentially affected by dirt. By executing shading correction using the first white reference data and the first black reference data, it is possible to reduce the influence of dirt on the background region 46 different from the document region 45. Therefore, by setting the document region 45 based on the first result, the accuracy of cutting out the document M can be improved.

(2-2) The second white reference data and the first black reference data are data that are not affected by dirt. By performing shading correction using the second white reference data and the first black reference data, it is possible to reduce the influence of dirt on the document region 45. Therefore, by cutting out the document region 45 set based on the first result from the second result, it is possible to cut out an image on which the influence of dirt is reduced.

(2-3) Upon receiving an instruction to read the document M, the control unit 37 may generate the first white reference data and the first black reference data. That is, since the control unit 37 uses data immediately before reading the document M, it is possible to execute highly accurate shading correction.

(2-4) The second white reference data is data generated during manufacturing. The storage unit 38 stores the second white reference data. Therefore, the control unit 37 can easily execute shading correction using the second white reference data that is not affected by dirt.

(2-5) The control unit 37 executes shading correction using the corrected second white reference data. Therefore, for example, even when the environment at the time of manufacturing is different from the environment at the time of use, the influence of the environment can be reduced.

### Third Embodiment

Next, the third embodiment of an image reading device will be described. In the third embodiment, the color of a reference portion is different from that of the second embodiment. Further, since other points are substantially the same as those of the second embodiment, duplicate descriptions of the same configuration will be omitted while assigning the same reference signs to the same components. The reference portion 33 according to the present embodiment is gray. A background region 46 according to the present embodiment is gray.

### Image Reading Method

As in the second embodiment, a control unit 37 generates a setting image 42 based on Equation 3 and generates a read image 43 based on Equation 4.

The read data, the first black reference data, and the second white reference data are data similar to those of the second embodiment. That is, the first black reference data is data that is obtained by reading a reference portion 33 by a reading unit 32 with a light source 31 turned off and that is not affected by dirt. The control unit 37 may execute shading correction after correcting the second white reference data stored in a storage unit 38.

The first white reference data is data obtained by multiplying, by the ratio between white and the color of the reference portion 33, data that is obtained by reading the reference portion 33 by the reading unit 32 with the light source 31 turned on and that is potentially affected by dirt. The control unit 37 may generate the first white reference data by multiplying the data read by the reading unit 32 by the quotient obtained by dividing the luminance value of white by the luminance value of the color of the reference portion 33. The color ratio between white and the reference portion 33 may be stored in, for example, the storage unit 38. Upon receiving an instruction to read the document M, the control unit 37 may generate the first white reference data and the first black reference data.

The control unit 37 sets the document region 45 based on the first result obtained by executing shading correction based on Equation 3. The control unit 37 may set the document region 45 based on a plurality of threshold values. For example, the first threshold is greater than the second threshold. When the first result is equal to or greater than the first threshold value or equal to or less than the second threshold value, the control unit 37 may determine that a given pixel is a pixel in the document region 45. When the first result is smaller than the first threshold value and larger than the second threshold value, the control unit 37 may determine that a given pixel is a pixel in the background region 46.

As indicated by Equation 4, the control unit 37 cuts out the document region 45 from the second result obtained by executing shading correction based on the difference between the read data and the first black reference data and the difference between the second white reference data and the first black reference data. That is, the control unit 37 cuts out the range of the document region 45 set based on the first result from the read image 43.

### Modification Examples

The embodiment can be modified and implemented as follows. The embodiment and the following modified examples can be implemented in combination with each other within a range in which no technical contradictions arise.
The image reading device 11 may include a plurality of reference portions 33 having different colors. The image reading device 11 may change the reference portion 33 in accordance with the document M to be read. The control unit 37 may select an equation for performing shading correction in accordance with the color of the reference portion 33.
The control unit 37 may not generate the setting image 42. The control unit 37 may set the document region 45 from a plurality of first results which are original data of the setting image 42.
In reading both sides of the document M, based on the document region 45 set on one side, the control unit 37 may cut out the other side. For example, the control unit 37 may set the document region 45 by performing the shading correction according to Equation 1 or 3 using the read data obtained by reading the obverse surface. The control unit 37 may not perform the shading correction according to Equation 1 or 3 with respect to the read data obtained by reading the reverse surface and may set a range obtained by reversing the document region 45 on the obverse surface as the document region 45 on the reverse surface.
In the first embodiment, the control unit 37 may perform shading correction after correcting the first white reference data stored in the storage unit 38 like, for example, the second white reference data according to the second embodiment.
In the second embodiment and the third embodiment, the control unit 37 may not correct the second white reference data. The control unit 37 may directly use the second white reference data stored in storage unit 38 for shading correction.
The storage unit 38 may be provided in a device different from the image reading device 11. For example, the control unit 37 may acquire the first white reference data or the second white reference data from a terminal such as a personal computer or a smartphone communicably connected to the image reading device 11. The control unit 37 may acquire the first white reference data or the second white reference data from a server via, for example, a network.
In the first embodiment, the control unit 37 may generate at least one of the first black reference data and the second black reference data. In the second and third embodiments, the control unit 37 may generate at least one of the first white reference data and the first black reference data. The control unit 37 may generate these data at, for example, a timing at which the power of the image reading device 11 is turned on or a timing at which the power is turned off.

In the first embodiment, the storage unit 38 may store at least one of the first black reference data and the second black reference data.

In the second and third embodiments, the storage unit 38 may store at least one of the first white reference data and the first black reference data.
In the first embodiment, the control unit 37 may set the document region 45 based on the first result obtained by performing shading correction according to Equation 1 and execute shading correction according to Equation 2 with respect to the read data corresponding to the document region 45 to generate an image on the document region 45. That is, the control unit 37 may execute shading correction after cutting out the document region 45. Similarly, in the second and third embodiments, the shading correction according to Equation 2 may not be performed with respect to the read data corresponding to the background region 46.
The image reading device 11 may be a device that reads one side of the document M. The image reading device 11 may include one light source 31, one reading unit 32, and one reference portion 33.
The image reading device 11 may read the document M such as colored paper, color paper, or copy paper.
The image reading device 11 may be mounted on a recording device such as a printer.
The image reading device 11 may output read data read by the reading unit 32 to an external device such as a personal computer or a smartphone. An external device may execute shading correction according to Equation 1 or 3 and set the document region 45 based on the first result. An external device may execute shading correction according to Equation 2 or 4 and cut out the document region 45 from the second result.

### Definition

As used herein, the phrase “at least one of” means one or more of specific alternatives. As an example, the phrase “at least one of” as used herein means only one alternative or both of two alternatives, when the number of alternatives is two. As another example, the phrase “at least one of” as used herein means only one alternative, or any combination of two or more alternatives, when the number of alternatives is three or more.

### Additional Notes

Hereinafter, technical ideas and effects thereof ascertained from the above-described embodiments and modification examples will be described.

(A) An image reading device includes a light source that emits light, a reference portion for shading correction, a reading unit that reads a document and outputs read data, and a control unit. One of first black reference data and first white reference data is data that is obtained by reading the reference portion by the reading unit with the light source turned on and that is potentially affected by dirt. The control unit sets a document region based on a first result obtained by executing shading correction based on a difference between the read data and the first black reference data and a difference between the first white reference data and the first black reference data.

According to this configuration, one of the first black reference data and the first white reference data is data that may be affected by dirt. By executing shading correction using the first black reference data and the first white reference data, it is possible to reduce the influence of dirt on the background region different from the document region. Therefore, by setting the document region based on the first result, the accuracy of cutting out the document can be improved.

(B) In the image reading device, the reference portion may be black, the first black reference data may be data that is obtained by reading the reference portion by the reading unit with the light source turned on and that is potentially affected by dirt, the first white reference data may be data not affected by dirt, second black reference data may be data not affected by dirt, and the control unit may cut out the document region from a second result obtained by executing shading correction based on a difference between the read data and the second black reference data and a difference between the first white reference data and the second black reference data.

According to this configuration, the first white reference data and the second black reference data are data that are not affected by dirt. By performing shading correction using the first white reference data and the second black reference data, it is possible to reduce the influence of dirt on the document region. Therefore, by cutting out the document region set based on the first result from the second result, it is possible to cut out an image on which the influence of dirt is reduced.

(C) In the image reading device, upon receiving an instruction to read the document, the control unit may generate the first black reference data and the second black reference data.

According to this configuration, the control unit generates the first black reference data and the second black reference data upon receiving an instruction to read a document. That is, since the control unit uses data immediately before reading the document, it is possible to execute highly accurate shading correction.

(D) In the image reading device, the control unit may generate the second black reference data by turning off the light source and causing the reading unit to read the reference portion.

According to this configuration, the control unit generates the second black reference data by causing the reference portion to be read with the light source turned off. Therefore, it is possible to easily generate the second black reference data not affected by dirt.

(E) In the image reading device, the reference portion may be white, the first white reference data may be data that is obtained by reading the reference portion by the reading unit with the light source turned on and that is potentially affected by dirt, the first black reference data may be data that is obtained by reading the reference portion by the reading unit with the light source turned off and that is not affected by dirt, second white reference data may be data not affected by dirt, and the control unit may cut out the document region from a second result obtained by executing shading correction based on the difference between the read data and the first black reference data and a difference between the second white reference data and the first black reference data.

According to this configuration, the second white reference data and the first black reference data are data that are not affected by dirt. By performing shading correction using the second white reference data and the first black reference data, it is possible to reduce the influence of dirt on the document region. Therefore, by cutting out the document region set based on the first result from the second result, it is possible to cut out an image on which the influence of dirt is reduced.

(F) In the image reading device, upon receiving an instruction to read the document, the control unit may generate the first white reference data and the first black reference data.

According to this configuration, the control unit generates the first white reference data and the first black reference data upon receiving an instruction to read a document. That is, since the control unit uses data immediately before reading the document, it is possible to execute highly accurate shading correction.

(G) In the image reading device, the color of the reference portion may be gray, the first white reference data may be data obtained by multiplying, by the ratio between white and the color of the reference portion, data that is obtained by reading the reference portion by the reading unit with the light source turned on and that is potentially affected by dirt, the first black reference data may be data that is obtained by reading the reference portion by the reading unit with the light source turned off and that is not affected by dirt, second white reference data may be data not affected by dirt, and the control unit may cut out the document region from a second result obtained by executing shading correction based on the difference between the read data and the first black reference data and a difference between the second white reference data and the first black reference data. According to such a configuration, the same effects as those of the image reading device can be obtained.

(H) In the image reading device, upon receiving an instruction to read the document, the control unit may generate the first white reference data and the first black reference data.

According to such a configuration, the same effects as those of the image reading device can be obtained.

(I) The image reading device may include a storage unit storing the second white reference data generated during manufacturing of the image reading device.

According to this configuration, the second white reference data is data generated during manufacturing. The storage unit stores the second white reference data. Therefore, the control unit can easily execute shading correction using the second white reference data that is not affected by dirt.

(J) In the image reading device, the control unit may correct the second white reference data stored in the storage unit before executing shading correction.

According to this configuration, the control unit executes shading correction using the corrected second white reference data. Therefore, for example, even when the environment at the time of manufacturing is different from the environment at the time of use, the influence of the environment can be reduced.

(K) An image reading method is an image reading method for an image reading device including a light source that emits light, a reference portion for shading correction, and a reading unit that reads a document and outputs read data. One of first black reference data and first white reference data is data that is obtained by reading the reference portion by the reading unit with the light source turned on and that is potentially affected by dirt, and a document region is set based on a first result obtained by executing shading correction based on a difference between the read data and the first black reference data and a difference between the first white reference data and the first black reference data.

According to this method, the same effects as those of the image reading device can be obtained.

What is claimed is:

1. An image reading device comprising:
a light source configured to emit light;
a reference portion for shading correction;
a reading unit configured to read a document and output read data; and
a control unit, wherein
one of first black reference data and first white reference data is data that is obtained by reading the reference portion by the reading unit with the light source turned on and that is potentially affected by dirt and
the control unit sets a document region based on a first result obtained by executing shading correction based on a difference between the read data and the first black reference data and a difference between the first white reference data and the first black reference data.

2. The image reading device according to claim 1, wherein
the reference portion is black,
the first black reference data is data that is obtained by reading the reference portion by the reading unit with the light source turned on and that is potentially affected by dirt,
the first white reference data is data not affected by dirt,
second black reference data is data not affected by dirt, and
the control unit cuts out the document region from a second result obtained by executing shading correction based on a difference between the read data and the second black reference data and a difference between the first white reference data and the second black reference data.

3. The image reading device according to claim 2, wherein
upon receiving an instruction to read the document, the control unit generates the first black reference data and the second black reference data.

4. The image reading device according to claim 2, wherein
the control unit generates the second black reference data by turning off the light source and causing the reading unit to read the reference portion.

5. The image reading device according to claim 1, wherein
the reference portion is white,
the first white reference data is data that is obtained by reading the reference portion by the reading unit with the light source turned on and that is potentially affected by dirt,
the first black reference data is data that is obtained by reading the reference portion by the reading unit with the light source turned off and that is not affected by dirt,
second white reference data is data not affected by dirt, and
the control unit cuts out the document region from a second result obtained by executing shading correction based on the difference between the read data and the first black reference data and a difference between the second white reference data and the first black reference data.

6. The image reading device according to claim 5, wherein
upon receiving an instruction to read the document, the control unit generates the first white reference data and the first black reference data.

7. The image reading device according to claim 1, wherein
a color of the reference portion is gray,
the first white reference data is data obtained by multiplying, by a ratio between white and the color of the reference portion, data that is obtained by reading the reference portion by the reading unit with the light source turned on and that is potentially affected by dirt,
the first black reference data is data that is obtained by reading the reference portion by the reading unit with the light source turned off and that is not affected by dirt,
second white reference data is data not affected by dirt, and
the control unit cuts out the document region from a second result obtained by executing shading correction based on the difference between the read data and the first black reference data and a difference between the second white reference data and the first black reference data.

8. The image reading device according to claim 7, wherein
upon receiving an instruction to read the document, the control unit generates the first white reference data and the first black reference data.

9. The image reading device according to claim 5, further comprising
a storage unit storing the second white reference data generated during manufacturing of the image reading device.

10. The image reading device according to claim 9, wherein
the control unit corrects the second white reference data stored in the storage unit before executing shading correction.

11. An image reading method for an image reading device including a light source that emits light, a reference portion for shading correction, and a reading unit that reads a document and outputs read data, wherein
one of first black reference data and first white reference data is data that is obtained by reading the reference portion by the reading unit with the light source turned on and that is potentially affected by dirt and
a document region is set based on a first result obtained by executing shading correction based on a difference between the read data and the first black reference data and a difference between the first white reference data and the first black reference data.
